(19) United States
(12) Patent Application Publication
(10) Pub. No.: US 2002/0181013 A1
(43) Pub. Date: Dec. 5, 2002

(54) Printer selection system and method

(76) Inventor: Douglas Gerald Dunlap, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/873,653

(22) Filed: Jun. 4, 2001

(51) Int. Cl. B41B 1/00; G06F 15/00

(52) U.S. Cl. 358/1.15

(57) ABSTRACT

A system and method of selecting a printer from a plurality of printers to fulfill a print job of a user includes providing a printer selection system controller having a printing capability of the printers registered therewith. The printer selection system controller compares a print request for the print job with the printing capability of the printers to determine which of the printers have the printing capability to fulfill the print job. As such, the printer selection system controller compiles a list of at least one printer which has the printing capability to fulfill the print job and presents the list to the user.

### THE FIELD OF THE INVENTION

The present invention relates generally to print services, and more particularly, to a system and method of selecting a printer from a plurality of printers to fulfill a print job.

### BACKGROUND OF THE INVENTION

Typically, a user having a print job has at their disposal one or more printers for printing of the print job. To assess a capability of the printers to fulfill the print job, such as options and/or properties of the printers, however, the user must select a single printer and then explore the capability of that printer. Thus, the user may need to select each available printer and assess or explore the capabilities of each available printer individually to determine which printer has the printing capability to fulfill the print job.

Unfortunately, individually assessing or exploring all of the capabilities of all of the available printers is a tedious task. In addition, a user may not be aware of all of the available printers and, therefore, all of the available printing capabilities. The user, therefore, may be blindly selecting a printer for printing of the print job even though a printer more suitable for the print job is available.

Accordingly, a need exists for selecting a printer from a plurality of printers to fulfill a print job of a user. More particularly, a need exists for identifying for the user which of the plurality of printers have the capability to fulfill the print job.

### SUMMARY OF THE INVENTION

One aspect of the present invention provides a method of selecting a printer from a plurality of printers to fulfill a print job of a user. The method includes registering a printing capability of the printers, receiving a print request for the print job from the user, and determining which of the printers have the printing capability to fulfill the print job. In addition, the method includes compiling a list of at least one of the printers which has the printing capability to fulfill the print job and presenting the list to the user. The step of determining which of the printers have the printing capability to fulfill the print job includes comparing the print request for the print job with the printing capability of the printers.

Another aspect of the present invention provides a computer-readable medium having computer-executable instructions for performing a method of selecting a printer from a plurality of printers to fulfill a print job of a user. The method includes registering a printing capability of the printers, receiving a print request for the print job from the user, determining which of the printers have the printing capability to fulfill the print job, compiling a list of at least one of the printers which has the printing capability to fulfill the print job, and presenting the list of the at least one of the printers to the user. As such, determining which of the printers have the printing capability to fulfill the print job includes comparing the print request for the print job with the printing capability of the printers.

Another aspect of the present invention provides a system for selecting a printer from a plurality of printers to fulfill a print job of a user. The system includes a memory device configured to have a printing capability of the printers stored therein and a processor adapted to compare a print request for the print job with the printing capability of printers to determine which of the printers have the printing capability to fulfill the print job. As such, the processor is adapted to compile a list of at least one of the printers which has the printing capability to fulfill the print job.

In one embodiment, the present invention provides a system and method of selecting a printer from a plurality of printers to fulfill a print job. The system and method compares a print request for the print job with a printing capability of the printers to determine which of the printers can fulfill the print job.

### BRIEF DESCRIPTION OF THE DRAWINGS

FIG. 1 is a block diagram illustrating one exemplary embodiment of a printer selection system according to the present invention.

FIG. 2 is a block diagram illustrating one exemplary embodiment of information flow through a portion of the printer selection system of FIG. 1.

FIG. 3 is a diagram illustrating one exemplary embodiment of a printing capability of a printer registered with the printer selection system of FIG. 1.

FIG. 4 is a block diagram illustrating one exemplary embodiment of information flow through a portion of the printer selection system of FIG. 1.

FIG. 5 is a diagram illustrating one exemplary embodiment of a portion of a user interface of the printer selection system of FIG. 1.

FIG. 6 is a diagram illustrating one exemplary embodiment of a print request for a print job received by the printer selection system of FIG. 1.

FIG. 7 is a block diagram illustrating one exemplary embodiment of information flow through the printer selection system of FIG. 1.

FIG. 8 is a flow diagram illustrating one exemplary embodiment of a method of selecting a printer from a plurality of printers for a print job according to the present invention.

### DESCRIPTION OF THE PREFERRED EMBODIMENTS

In the following detailed description of the preferred embodiments, reference is made to the accompanying drawings which form a part hereof, and in which is shown by way of illustration specific embodiments in which the invention may be practiced. It is to be understood that other embodiments may be utilized and structural or logical changes may be made without departing from the scope of the present invention. The following detailed description, therefore, is not to be taken in a limiting sense, and the scope of the present invention is defined by the appended claims.

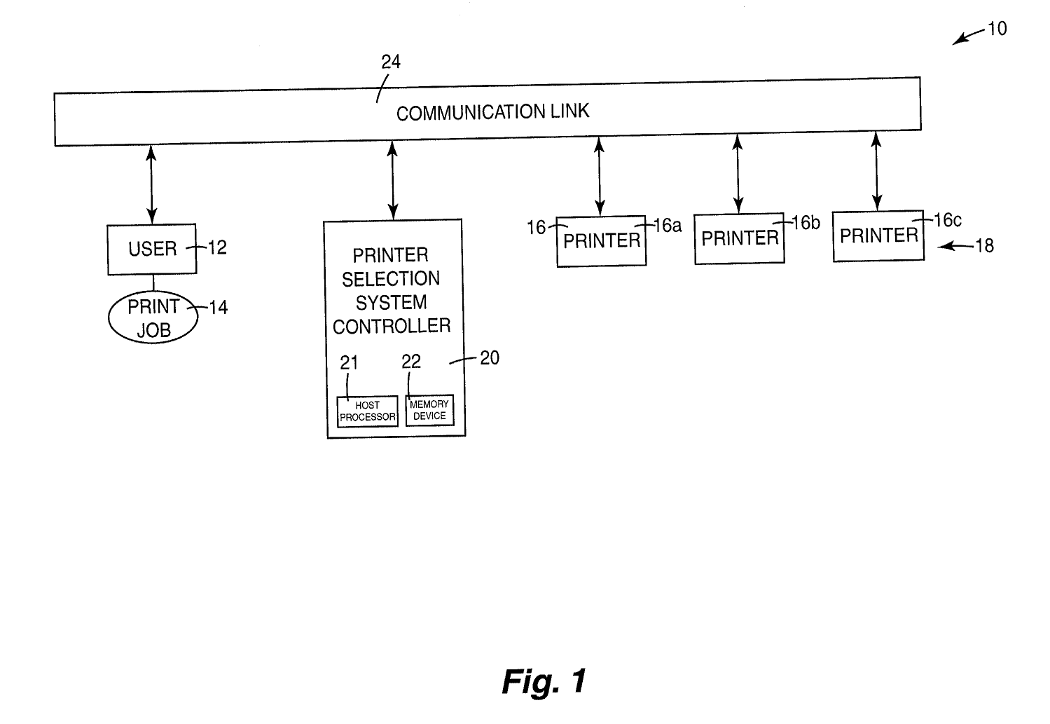

A printer selection system according to the present invention is illustrated generally at 10 in FIG. 1. Printer selection system 10 assists a user 12 having a print job 14 in selecting a printer 16a, 16b, 16c for print job 14. For clarity, printer 16a, 16b, 16c is referred to hereinafter as printer 16. As such, printer 16 is one of a plurality of printers 18 registered with printer selection system 10.

Printer 16, as used herein, is defined to include a printing device capable of producing printed output, including textural and/or graphical images, on a print medium, such as paper, in response to electronic signals. Examples of such a printing device include a laser jet printer, an inkjet printer, etc.

Printer selection system 10 includes a printer selection system controller 20 which determines which printer 16 of the plurality of printers 18 is capable of fulfilling print job 14. Printer selection system controller 20 includes hardware, software, firmware, or a combination of these. In one preferred embodiment, printer selection system controller 20 includes a host processor 21. Host processor 21 can be or can be included in a computer server or other microprocessor-based system capable of performing a sequence of logic operations. In addition, printer selection system controller 20 can include a microprocessor embedded system/appliance incorporating tailored appliance hardware and/or dedicated single purpose hardware.

In one exemplary embodiment, printer selection system controller 20 includes a memory device 22 which stores information for printer selection system controller 20 and/or printer selection system 10. Examples of memory device 22 include non-volatile memory (e.g., a hard disk drive or other persistent storage device) and may include volatile memory (e.g., random access memory (RAM)). Another example of memory device 22 may include a relational database management server (RDBMS). While memory device 22 is presented as part of printer selection system controller 20, it is within the scope of the present invention for memory device 22 to be separate from printer selection system controller 20.

User 12, printers 18, and printer selection system controller 20 communicate with each other via a communication link 24. Thus, communications between user 12 and printer selection system controller 20, communications between printers 18 and printer selection system controller 20, and communications between user 12 and printers 18 are conducted over communication link 24. Communication link 24, as used herein, is defined to include a network communication link such as a local-area network (LAN) link or a wide-area network (WAN) link and/or a communication link within a computer. Communication link 24, therefore, may include an intranet communication link, an Internet communication link, or a communication bus within a computer. In addition, communication link 24 may include a wireless communication link.

In one exemplary embodiment, user 12, printers 18, and printer selection system controller 20 are all located remote from each other (i.e., at different locations). Thus, communications between user 12, printers 18, and printer selection system controller 20 are conducted over a network communication link. It is, however, within the scope of the present invention for user 12 and printer selection system controller 20, printers 18 and printer selection system controller 20, and/or user 12 and printers 18 to be located at the same location. Thus, user 12, printers 18, and/or printer selection system controller 20 may communicate in other manners (e.g., a direct connection or communication link).

Components of printer selection system 10, including printer selection system controller 20, can be implemented in hardware via a microprocessor, programmable logic device, or state machine, in firmware, or in software within a given device. Programming languages and communication protocols suitable for use with printer selection system 10 will become apparent to those skilled in the art after reading the present application.

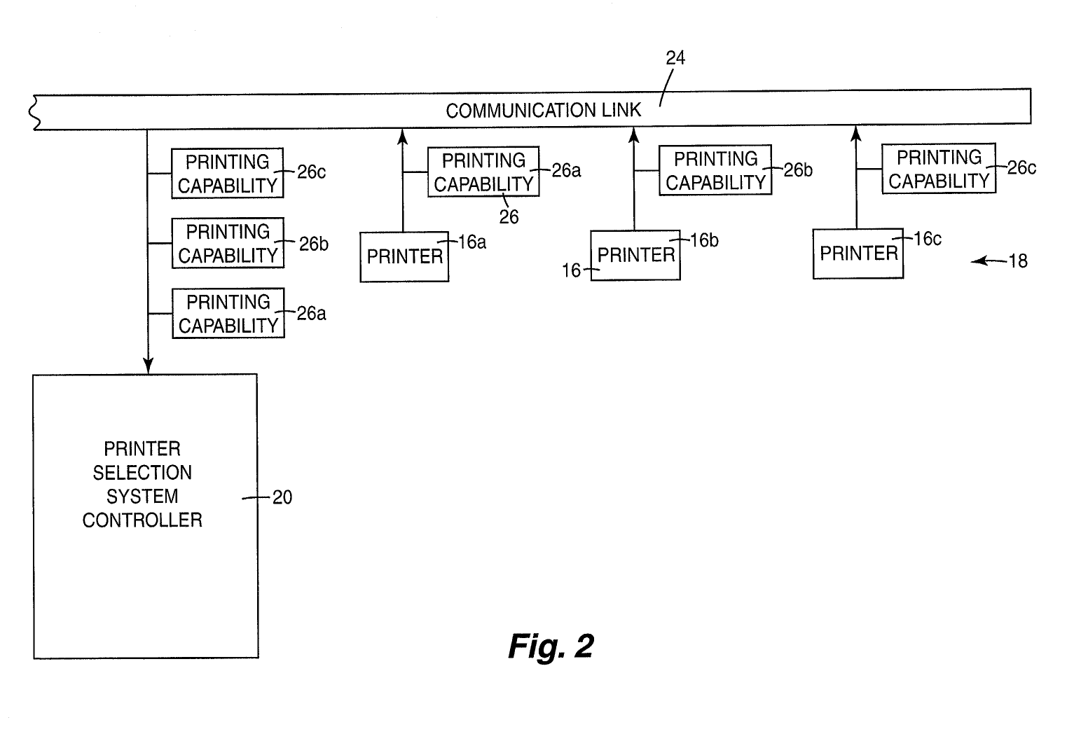

As illustrated in FIG. 2, a printing capability 26a, 26b, 26c of each respective printer 16a, 16b, 16c is registered with printer selection system controller 20 via communication link 24. For clarity, printing capability 26a, 26b, 26c is referred to hereinafter as printing capability 26. Printing capability 26 identifies attributes of a respective printer 16, as described below.

In one exemplary embodiment, printer selection system controller 20 communicates with and transfers printing capability 26 of printers 18 to memory device 22 (FIG. 1). As such, memory device 22 stores printing capability 26 of printers 18 for subsequent retrieval and processing. More specifically, when printer selection system controller 20 receives printing capability 26 from a respective printer 16, printing capability 26 is stored as a data file in memory device 22. Printer selection system controller 20, therefore, subsequently retrieves printing capability 26 from memory device 22 for processing.

In one exemplary embodiment, printer selection system 10 utilizes a network management protocol to register printing capability 26 of printers 18 with printer selection system controller 20. An example of a network management protocol suitable for use with printer selection system 10 includes a simple network management protocol (SNMP). As SNMP-compliant devices, printers 18 store data about themselves, including, for example, printing capability 26, and return this data to printer selection system controller 20, as an SNMP requester, when requested by printer selection system controller 20. Another example of a network management protocol suitable for use with printer selection system 10 includes a remote monitoring (RMON) network management protocol.

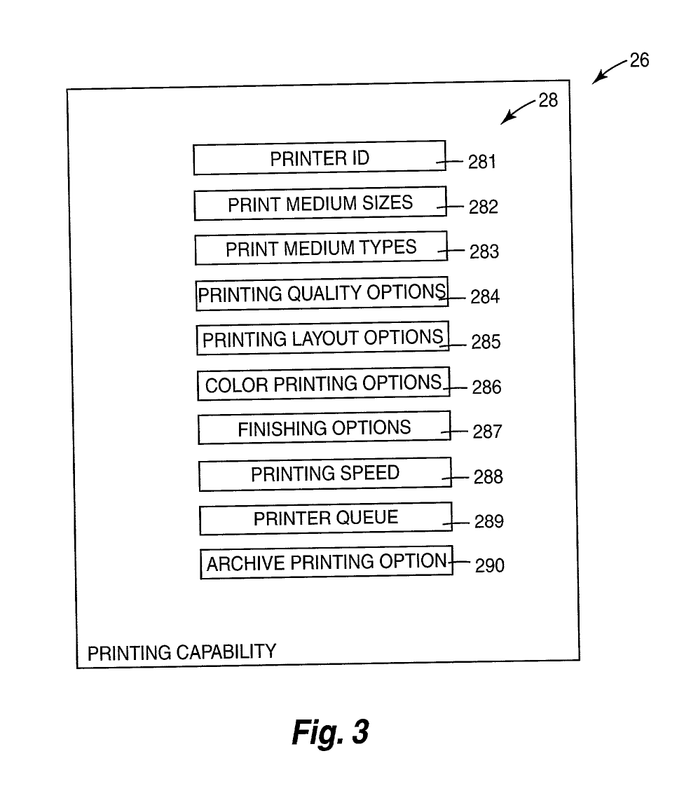

In one exemplary embodiment, as illustrated in FIG. 3, printing capability 26 includes a plurality of printing capability attributes 28 which define characteristics of each respective printer 16. Printing capability attributes 28 include, for example, a printer identification attribute 281, a print medium sizes attribute 282, a print medium types 283, a printing quality options attribute 284, a printing layout options attribute 285, a color printing options attribute 286, a finishing options attribute 287, a printing speed attribute 288, a printer queue attribute 289, and an archival printing option attribute 290.

Printer identification attribute 281 identifies, for example, a name and a location of printer 16, including a proximity of printer 16 to user 12. Print medium sizes attribute 282 identifies different sizes of print medium upon which printer 16 is capable of printing. Examples of different print medium sizes include a Letter-size, a Legal-size, and an A4-size of print medium. Print medium types attribute 283 identifies different types of print medium upon which printer 16 is capable of printing. Examples of different print medium types include Plain Paper, Bond Paper, and Transparencies.

Printing quality options attribute 284 identifies different printing qualities that printer 16 is capable of printing. An example of printing quality includes different printing resolutions such as 1200 dpi, 600 dpi, 300 dpi, etc. Printing layout options attribute 285 identifies different printing layouts that printer 16 is capable of printing. Examples of different printing layout options include Portrait and Landscape and Single-Sided and Double-Sided. Color printing options attribute 286 identifies different color printing options that printer 16 is capable of printing. Examples of different color printing options include Color Printing, Grayscale Printing, and Monochrome Printing.

Finishing options attribute 287 identifies different finishing options that printer 16 is capable of providing. Examples of different finishing options include Three-Hole Punched, Stapled, and Bound. Printing speed attribute 288 identifies a printing speed of printer 16. Examples of different printing speeds include, for example, 17 pages per minute, 24 pages per minute, and 32 pages per minute. Printer queue attribute 289 identifies, for example, a wait time for printing at printer 16 and an order of printing at printer 16. Archival printing option attribute 290 identifies an archive function of printer 16 such as an ability of printer 16 to retain print job 14 for subsequent printing.

It is understood that additional print medium sizes, print medium types, printing quality options, printing layout options, color printing options, finishing options, and printing speeds, as are well known in the art, may be identified with print medium sizes attribute 282, print medium types attribute 283, printing quality options attribute 284, printing layout options attribute 285, color printing options attribute 286, finishing options attribute 287, and printing speed attribute 288, respectively.

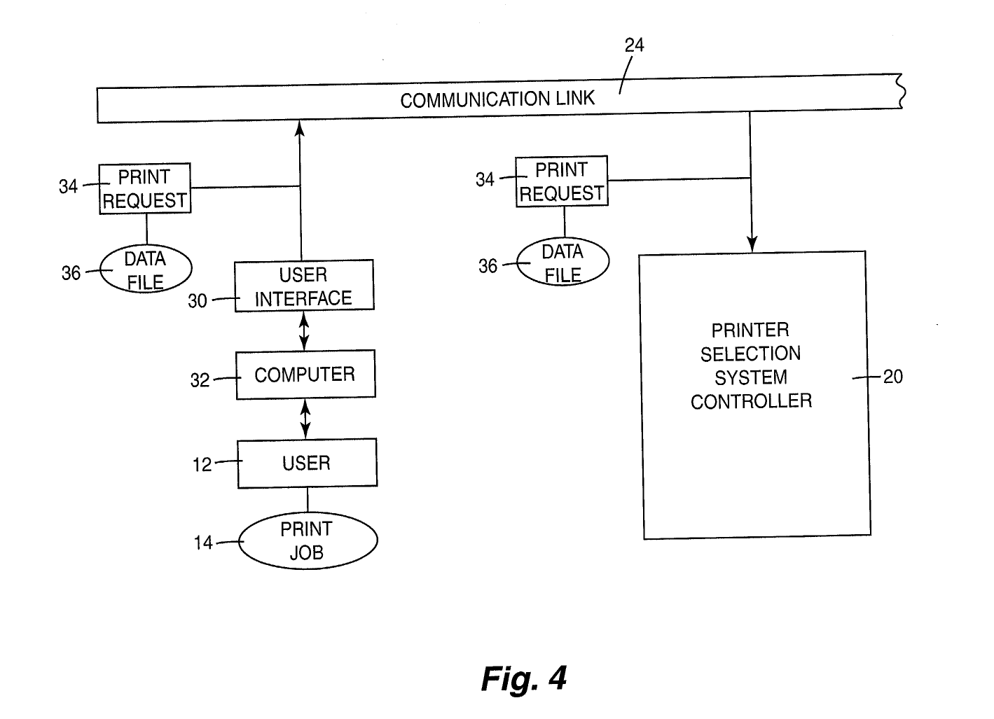

As illustrated in FIG. 4, user 12 accesses a user interface 30 of printer selection system 10 via a computer 32. Computer 32 may include, for example, an input device such as a keyboard and/or a mouse and a display device such as a monitor, as is well known in the art. Computer 32 may be an appliance such as a personal digital assistant (PDA), scanner, camera, cellular phone, etc. It is within the scope of the present invention for printer selection system 10 to be incorporated into computer 32 and, therefore, printer selection system controller 20 to be a component of computer 32. It is also within the scope of the present invention for multiple users 12 to utilize printer selection system 10. Thus, one or more users 12, each having a respective print job 14, may access printer selection system 10 from a respective computer 32.

In one exemplary embodiment, computer 32 runs an operating system which can support one or more applications. The operating system is stored in memory and executes on a processor. The operating system is preferably a multi-tasking operating system which allows simultaneous execution of multiple applications, although aspects of the present invention may be implemented using a single-tasking operating system.

User 12 interacts with user interface 30 via computer 32 to generate a print request 34 for print job 14 and submit print request 34 for print job 14 to printer selection system controller 20 via communication link 24. Print request 34 identifies attributes of print job 14 as specified by user 12. Print request 34, as used herein, is defined to include a list and/or a description of a piece of work requiring production and/or reproduction of printed matter.

In one exemplary embodiment, a data file 36 for print job 14 is associated with print request 34. As such, data file 36 is submitted with print request 34 and uploaded to printer selection system controller 20 via communication link 24.

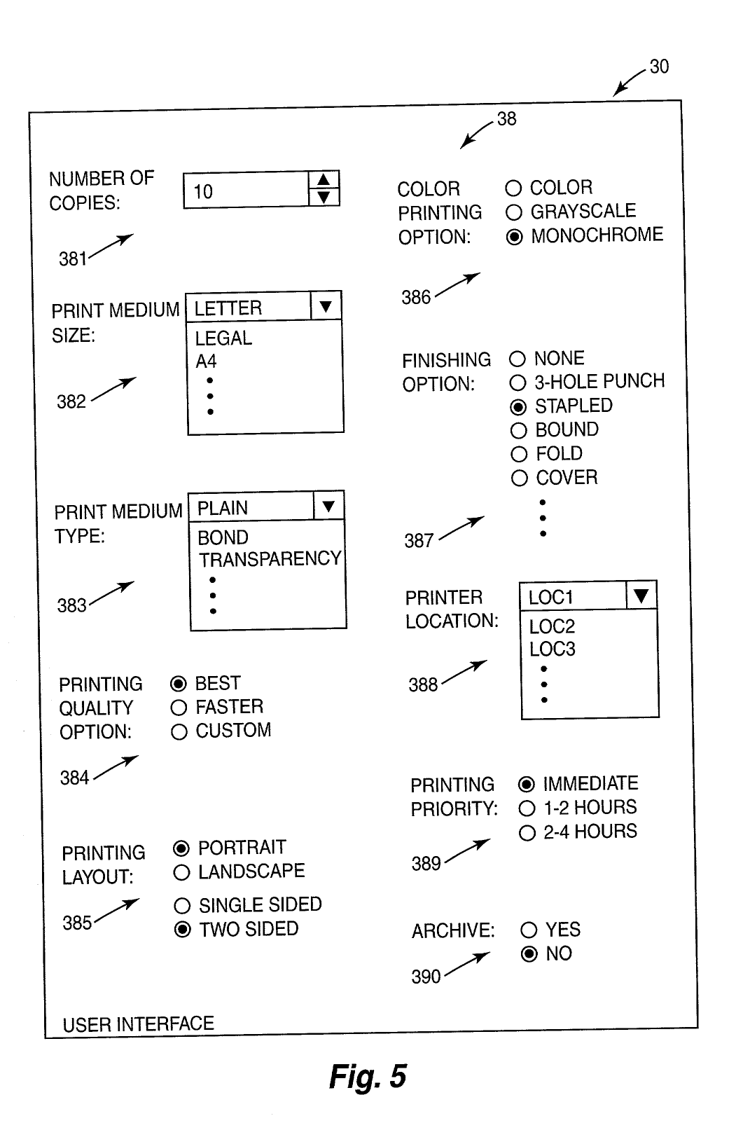

In one exemplary embodiment, as illustrated in FIG. 5, a portion of user interface 30 includes a plurality of input fields 38 with which user 12 interacts to specify attributes of print job 14. As such, user 12 interacts with input fields 38, via an input device such as a keyboard and/or a mouse of computer 32 or an appliance such as a personal digital assistant (PDA), scanner, camera, etc., to generate print request 34 for print job 14.

Input fields 38 include, for example, a number of copies field 381, a print medium size field 382, a print medium type field 383, a printing quality option field 384, a printing layout field 385, a color printing option field 386, a finishing option field 387, a printer location field 388, a printing priority field 389, and an archive option field 390. Input fields 38 each include at least one subfield providing data entry points or representing available options for generating and submitting print request 34.

Number of copies field 381 includes a subfield in which a number of copies included in print job 14 is specified. Print medium size field 382 includes subfields which represent different sizes of print medium for print job 14. Print medium type field 383 includes subfields which represent types of print medium for print job 14. Printing quality option field 384 includes subfields which represent different printing qualities, including different printing positions such as 1200 dpi, 600 dpi, 300 dpi, etc., for print job 14. Printing layout field 385 includes subfields which represent different printing layouts for print job 14. Color printing option field 386 includes subfields which represent different color printing options for print job 14. Finishing option field 387 includes subfields which represent different finishing options for print job 14. Printer location field 388 includes subfields which represent different locations of printers for print job 14. Printing priority field 389 includes subfields which represent different priorities of printing print job 14. Archive option field 390 includes subfields for specifying archival of print job 14.

Additional print medium sizes, print medium types, printing quality options, printing layouts, color printing options, and finishing options, as are well known in the art, may be represented by additional subfields of print medium size field 382, print medium type field 383, printing quality option field 384, printing layout field 385, color printing option field 386, and finishing option field 387, respectively.

Selecting and/or completing various subfields of input fields 38, therefore, identifies attributes of print job 14 as specified by user 12. In one exemplary embodiment, input of specific input fields 38 dictates a selection of other input fields 38. When user 12 selects a specific subfield, for example, additional subfields may appear and/or existing subfields may be unavailable. In addition, when user 12 selects a specific subfield, additional subfields may be automatically selected and/or completed. Furthermore, user 12 may store preferences of various subfields as common default selections.

It is to be understood that FIG. 5 is a simplified illustration of one exemplary embodiment of user interface 30. The illustrative presentation of input fields 38, including the respective subfields, has been simplified for clarity of the invention. The subfields, for example, may be presented as open fields, pull-down menus, toggle selections, and/or highlighted or framed selections. In addition, user interface 30 may be presented, for example, in one or more screens or views such that each screen or view includes one or more input fields 38. Furthermore, user 12 may generate print request 34 by responding to query-based systems or applications. It is understood that such alternatives are within the scope of the present invention.

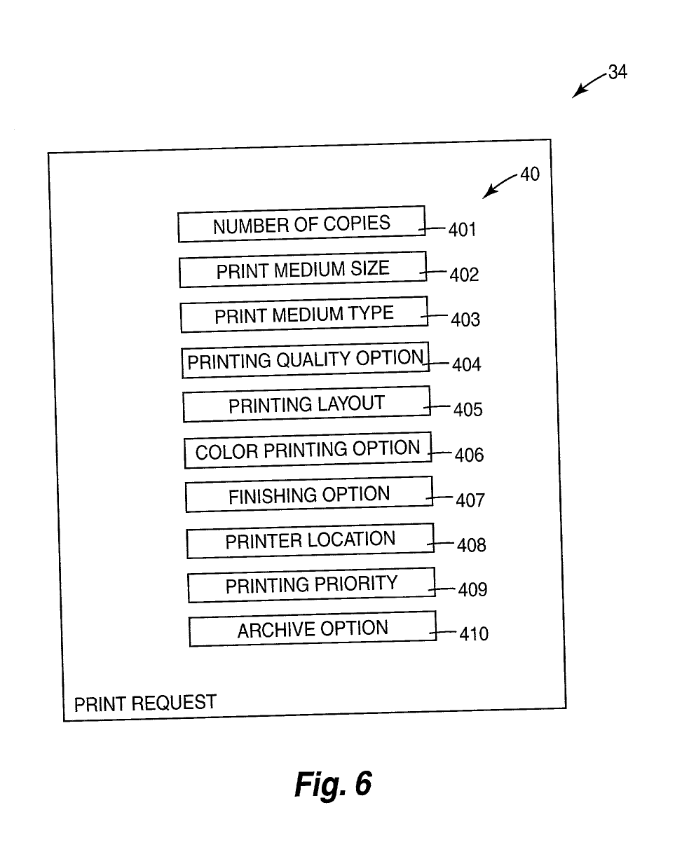

By interacting with user interface 30, user 12 generates print request 34. In one exemplary embodiment, as illustrated in FIG. 6, print request 34 includes a plurality of print request attributes 40 which define print job 14. Print request attributes 40 coincide with selections as specified by user 12 while interacting with user interface 30. As such, print request attributes 40 are conveyed to printer selection system controller 20 from user interface 30. Print request attributes 40 include, for example, a number of copies attribute 401, a print medium size attribute 402, a print medium type 403, a printing quality option attribute 404, a printing layout attribute 405, a color printing option attribute 406, a finishing option attribute 407, a printer location attribute 408, a printing priority attribute 409, and an archive option attribute 410.

Number of copies attribute 401 includes a number of copies included in print job 14. Print medium size attribute 402 includes a selected or desired size of print medium upon which print job 14 is to be printed. Print medium type attribute 403 includes a selected or desired type of print medium upon which print job 14 is to be printed. Printing quality option attribute 404 includes a selected or desired printing quality for print job 14. Printing layout attribute 405 includes a selected or desired layout of how print job 14 is to be printed. Color printing option attribute 406 includes a selected or desired color content for print job 14. Finishing option attribute 407 includes a selected or desired finish for print job 14. Printer location attribute 408 includes a selected or desired location of a printer for printing of print job 14. Printing priority attribute 409 includes a selected or desired priority for completion of print job 14. Archive attribute 410 includes a selected or desired storage and/or subsequent printing of print job 14.

To assist user 12 in selecting printer 16 for printing print job 14, printer selection system controller 20 determines which printers 18 have printing capability 26 to fulfill print job 14. As such, printer selection system controller 20 compares print request 34 for print job 14 with printing capability 26 of printers 18.

It is understood that print request attributes 40 of print request 34 may be conveyed individually to printer selection system controller 20 as print request attributes 40 are selected or specified. Thus, printer selection system controller 20 identifies which printers 18 fulfill print request 34 and, therefore, print job 14, as print request attributes 40 are received. Which printers 18 fulfill print request 34, therefore, may be limited and/or narrowed as additional print request attributes 40 are received.

In one exemplary embodiment, printer selection system controller 20 determines a number of pages of print job 14 from data file 36. As such, printer selection system controller 20 selects printer 16 based on the number of pages of print job 14. If, for example, the number of pages of print job 14 is greater than a predetermined number, then printer selection system controller 20 identifies which printers 18 can print print job 14 the fastest based on printing speed attribute 288 and/or which printers 18 can print print job 14 in duplex form based on printing layout options attribute 285.

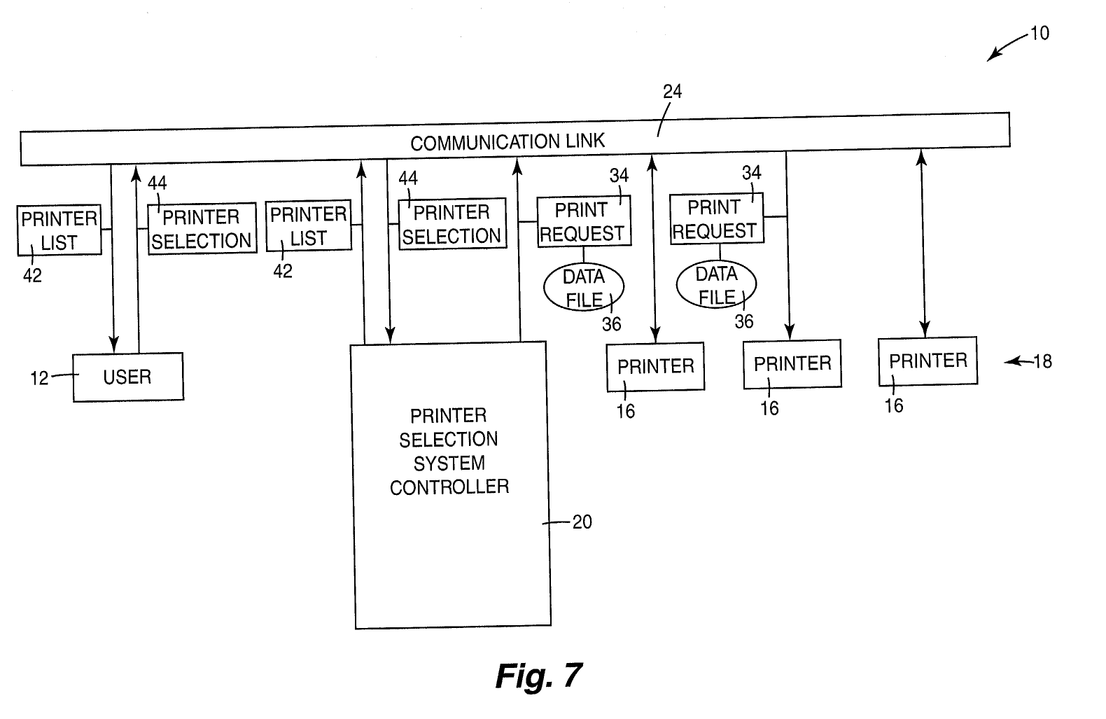

In one exemplary embodiment, as illustrated in FIG. 7, printer selection system controller 20 compiles a list 42 of printers 18 which have printing capability 26 to fulfill print job 14 and presents list 42 to user 12 via communication link 24. As such, user 12 selects at least one printer 16 from list 42 for printing of print job 14. In one exemplary embodiment, user 12 submits a printer selection 44 identifying the selected printer to printer selection system controller 20 via communication link 24. Thus, printer selection system controller 20 receives printer selection 44 and distributes print request 34 and data file 36 for print job 14 to the selected printer 16 via communication link 24. User 12, therefore, distributes print request 34 and data file 36 for print job 14 to the selected printer 16 through printer selection system controller 20. It is, however, within the scope of the present invention for user 12 to select at least one printer 16 from list 42 for printing of print job 14 and distribute print request 34 and data file 36 for print job 14 directly to the selected printer 16.

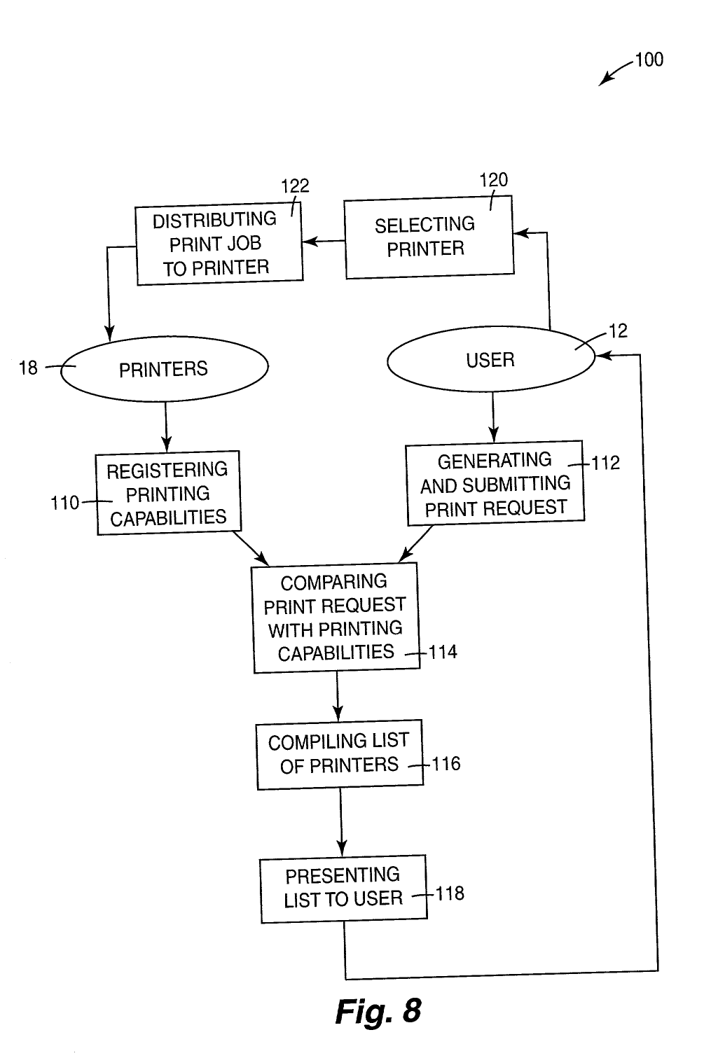

In FIG. 8, a flow diagram illustrating one exemplary embodiment of a method of selecting a printer 16 from a plurality of printers 18 to fulfill print job 14 according to the present invention is illustrated generally at 100. Reference is also made to FIGS. 1-7. At step 110, a respective printing capability 26 of printers 18 is registered with printer selection system controller 20 and, at step 112, user 12 generates and submits print request 34 for print job 14 to printer selection system controller 20. In one exemplary embodiment, printing capability 26 of printers 18 is registered with printer selection system controller 20 via communication link 24, as illustrated in FIG. 2, and user 12 submits print request 34 to printer selection system controller 20 via communication link 24, as illustrated in FIG. 4.

Preferably, printing capability 26 of printers 18 is registered at step 110 before user 12 generates and submits print request 34 at step 112. It is, however, within the scope of the present invention for printing capability 26 of printers 18 to be registered with printer selection system controller 20 after user 12 submits print request 34 to printer selection system controller 20. As such, after printer selection system controller 20 receives print request 34, printer selection system controller 20 requests and receives printing capability 26 from printers 18. In addition, it is also within the scope of the present invention for printing capability 26 of printers 18 to be re-registered or updated with printer selection system controller 20. If, for example, printers 18 are added, deleted, and/or upgraded, printing capability 26 can be updated. Furthermore, it is also within the scope of the present invention for user 12 to re-generate and/or re-submit print request 34 to printer selection system controller 20.

Next, in step 114, after printer selection system controller 20 receives print request 34, printer selection system controller 20 determines which printers 18 have printing capability 26 to fulfill print job 14. As such, printer selection system controller 20 compares print request 34 for print job 14 with printing capability 26 of printers 18.

To compare print request 34 for print job 14 with printing capability 26 of printers 18, print request attributes 40 of print job 14, as specified by user 12, are compared with printing capability attributes 28 of printers 18, as registered with and/or received by printer selection system controller 20. Thus, printer selection system controller 20 determines which printers 18 have printing capability 26 to fulfill print request 34 and, therefore, complete print job 14. Accordingly, only those printers 18 which have printing capability 26 to fulfill print request 34 are identified in step 114.

Next, in step 116, list 42 of printers 18 which have printing capability 26 to fulfill print request 34, as established by printer selection system controller 20 in step 114, is compiled and, in step 118, is presented to user 12. In one exemplary embodiment, list 42 is presented to user 12 via communication link 24, as illustrated in FIG. 7.

Next, in step 120, user 12 selects at least one printer 16 from list 42 to complete print job 14. Thus, in one exemplary embodiment, user 12 submits printer selection 44 to printer selection system controller 20 via communication link 24, as illustrated in FIG. 7.

Then, in step 122, print request 34 and data file 36 for print job 14 are distributed to printer 16, as selected in step 120.

In one exemplary embodiment, steps 110-122 of method 100 are performed via computer-executable instructions of a computer-readable medium. Computer-readable medium, as used herein, is defined to include any kind of computer memory such as a floppy disk, conventional hard disk, CD-ROM, Flash ROM, nonvolatile ROM, RAM, etc.

By comparing print request 34 for print job 14 with printing capability 26 of printers 18, printer selection system 10 automatically determines which printers 18 have printing capability 26 to fulfill print job 14. Thus, when selecting a printer for print job 14, it is not necessary for user 12 to know which printer 16 has the capability to fulfill print job 14. As such, it is not necessary for user 12 to explore the capabilities of each printer to identify which printer can fulfill print job 14.

Although specific embodiments have been illustrated and described herein for purposes of description of the preferred embodiment, it will be appreciated by those of ordinary skill in the art that a wide variety of alternate and/or equivalent implementations may be substituted for the specific embodiments shown and described without departing from the scope of the present invention. Those with skill in the chemical, mechanical, electromechanical, electrical, and computer arts will readily appreciate that the present invention may be implemented in a very wide variety of embodiments. This application is intended to cover any adaptations or variations of the preferred embodiments discussed herein. Therefore, it is manifestly intended that this invention be limited only by the claims and the equivalents thereof.

What is claimed is:

1. A method of selecting a printer from a plurality of printers to fulfill a print job of a user, the method comprising the steps of:
registering a printing capability of the printers;
receiving a print request for the print job from the user;
determining which of the printers have the printing capability to fulfill the print job, including comparing the print request for the print job with the printing capability of the printers;
compiling a list of at least one of the printers which has the printing capability to fulfill the print job; and
presenting the list of the at least one of the printers to the user.

2. The method of claim 1, wherein the step of registering the printing capability includes registering the printing capability of the printers with a printer selection system controller, wherein the step of receiving the print request includes receiving the print request for the print job from the user at the printer selection system controller, and wherein the step of determining which of the printers have the printing capability to fulfill the print job includes determining via the printer selection system controller which of the printers have the printing capability to fulfill the print job.

3. The method of claim 2, further comprising the step of:
linking the user and the printer selection system controller via a communication link, wherein the step of presenting the list includes presenting the list of the at least one of the printers to the user via the communication link.

4. The method of claim 2, further comprising the step of:
receiving a printer selection for the print job from the user at the printer selection system controller, wherein the printer selection includes a selected printer from the list of the at least one of the printers.

5. The method of claim 4, further comprising the step of:
linking the user and the printer selection system controller via a communication link, wherein the step of receiving the printer selection includes receiving the printer selection for the print job from the user via the communication link.

6. The method of claim 4, further comprising the step of:
distributing the print request to the selected printer.

7. The method of claim 6, further comprising the step of:
linking the printers and the printer selection system controller via a communication link, wherein the step of distributing the print request includes distributing the print request to the selected printer via the communication link.

8. The method of claim 1, further comprising the step of:
presenting to the user a user interface including at least one input field representing at least one option for the print job, wherein the step of receiving the print request includes receiving at least one attribute for the print job as specified with the at least one input field of the user interface.

9. The method of claim 1, wherein the step of receiving the print request includes receiving at least one of a number of copies, a print medium, a printing quality option, a printing layout, a color printing option, a finishing option, a printer location, a printing priority, and an archive option for the print job.

10. The method of claim 2, further comprising the step of:
linking the user and the printer selection system controller via a communication link, wherein the step of receiving the print request includes receiving the print request for the print job from the user via the communication link.

11. The method of claim 2, further comprising the step of:
associating a data file for the print job with the print request for the print job, wherein the step of receiving the print request includes receiving the print request and the data file from the user at the printer selection system controller, and wherein the step of determining which of the printers have the printing capability to fulfill the print job includes comparing the print request and the data file with the printing capability of the printers.

12. The method of claim 2, further comprising the step of:
linking the printers and the printer selection system controller via a communication link, wherein the step of registering the printing capability includes registering the printing capability of the printers with the printer selection system controller via the communication link.

13. The method of claim 1, wherein the step of registering the printing capability includes registering at least one of an identification, a print medium capability, a print quality capability, a printing layout capability, a color printing capability, a finishing capability, a printing speed, a printer queue, and an archive printing capability of the printers.

14. A computer-readable medium having computer-executable instructions for performing a method of selecting a printer from a plurality of printers to fulfill a print job of a user, the method comprising:
registering a printing capability of the printers;
receiving a print request for the print job from the user;
determining which of the printers have the printing capability to fulfill the print job, including comparing the print request for the print job with the printing capability of the printers;
compiling a list of at least one of the printers which has the printing capability to fulfill the print job; and
presenting the list of the at least one of the printers to the user.

15. The computer-readable medium of claim 14, wherein the method further comprises:
receiving a printer selection for the print job from the user, wherein the printer selection includes a selected printer from the list of the at least one of the printers.

16. The computer-readable medium of claim 15, wherein the method further comprises:
distributing the print request to the selected printer.

17. The computer-readable medium of claim 14, wherein the method further comprises:
presenting to the user a user interface including at least one input field representing at least one option for the print job, wherein receiving the print request includes receiving at least one attribute for the print job as specified with the at least one input field of the user interface.

18. The computer-readable medium of claim 14, wherein the method further comprises:
associating a data file for the print job with the print request for the print job, wherein receiving the print request includes receiving the print request and the data file from the user, and wherein determining which of the printers have the printing capability to fulfill the print job includes comparing the print request and the data file with the printing capability of the printers.

19. A system for selecting a printer from a plurality of printers to fulfill a print job of a user, the system comprising:
a memory device configured to have a printing capability of the printers stored therein; and
a processor adapted to compare a print request for the print job with the printing capability of the printers to determine which of the printers have the printing capability to fulfill the print job, wherein the processor is adapted to compile a list of at least one of the printers which has the printing capability to fulfill the print job.

20. The system of claim 19, wherein the memory device and the processor are included in a printer selection system controller, wherein the printer selection system controller is adapted to receive the print request for the print job from the user and present the list of the at least one of the printers to the user.

21. The system of claim 20, further comprising:
a communication link configured to link the printer selection system controller and the user, wherein the printer selection system controller is adapted to receive the print request for the print job from the user via the communication link and present the list of the at least one of the printers to the user via the communication link.

22. The system of claim 20, wherein the printer selection system controller is adapted to receive a printer selection for the print job from the user, the printer selection including a selected printer from the list of the at least one of the printers, wherein the printer selection system controller is adapted to distribute the print request for the print job to the selected printer.

23. The system of claim 22, further comprising:
a communication link configured to link the printer selection system controller and the printers, wherein the printer selection system controller is adapted to distribute the print request for the print job to the selected printer via the communication link.

24. The system of claim 23, wherein the printer selection system controller is adapted to receive the printing capability of the printers from the printers via the communication link.

25. The system of claim 19, wherein the printing capability of the printers includes at least one of an identification, a print medium capability, a printing quality capability, a printing layout capability, a color printing capability, a finishing capability, a printing speed, a printer queue, and an archive capability of the printers.

26. The system of claim 19, further comprising:
a user interface including at least one input field representing at least one option for the print job, wherein the user interface includes at least one of a number of copies, a print medium, a printing quality option, a printing layout, a color printing option, a finishing option, a printer location, a printing priority, and an archive field.

27. The system of claim 19, wherein the print request includes at least one of a number of copies, a print medium, a printing quality option, a printing layout, a color printing option, a finishing option, a printer location, a printing priority, and an archive option for the print job.

28. The system of claim 20, wherein the printer selection system controller is adapted to receive the print request and a data file for the print job, and wherein the processor is adapted to compare the print request and the data file with the printing capability of the printers to determine which of the printers have the printing capability to fulfill the print job.

29. The system of claim 28, wherein the printer selection system controller is adapted to receive a printer selection for the print job from the user, the printer selection including a selected printer from the list of the at least one of the printers, wherein the printer selection system controller is adapted to distribute the print request and the data file for the print job to the selected printer.
